(19) United States
(12) Patent Application Publication
(10) Pub. No.: US 2023/0206251 A1
(43) Pub. Date: Jun. 29, 2023

(54) TECHNOLOGIES FOR USING MACHINE LEARNING TO ASSESS PRODUCTS AND PRODUCT SUPPLIERS

(71) Applicant: UL LLC, Northbrook, IL (US)

(72) Inventors: Saurav Acharya, Des Plaines, IL (US); Yizi Huang, Northbrook, IL (US); Shubhankar Mitra, North Brook, IL (US); Karan Sodhi, Northbrook, IL (US); Rashid Mehdiyev, Buffalo Grove, IL (US); Valeriy Liberman, Buffalo Grove, IL (US); Nida Batt, Northbrook, IL (US); Paul Ter Horst, Killiney (IE); Annie Ibrahim Rana, Dublin (IE)

(21) Appl. No.: 18/085,519

(22) Filed: Dec. 20, 2022

Related U.S. Application Data
(60) Provisional application No. 63/293,288, filed on Dec. 23, 2021.

(51) Int. Cl. G06Q 30/018; G06Q 10/087

(52) U.S. Cl. CPC G06Q 30/0185; G06Q 10/087

(57) ABSTRACT

Systems and methods for using machine learning to dynamically assess performance of products and suppliers in the marketplace are disclosed. According to certain aspects, an electronic device may train a plurality of intermediate machine learning models and an aggregate machine learning model using various marketplace data associated with products and suppliers. The electronic device may analyze information associated with a given product or a given supplier using the trained machine learning models to predict a performance of the product or supplier, as well as determine various recommendations associated with the design, testing, inspection, and/or distribution of products.

### CROSS-REFERENCE TO RELATED APPLICATIONS

This application claims priority to U.S. Patent Application No. 63/293,288, filed Dec. 23, 2021, the disclosure of which is hereby incorporated by reference in its entirety.

### FIELD

The present disclosure is directed to using machine learning techniques to assess products and product suppliers.

### BACKGROUND

Generally, there are many components and entities involved in the product lifecycle. In particular, a given product may undergo specification and design, production, inspection, testing, distribution, and sales. Once in the marketplace, the product may experience returns, reviews, complaints, and/or other feedback.

Currently, retailers incur high costs associated with poor product quality that may result from management of product returns, consumer complaints, recalls, and/or other factors. As a result, the retailers are exposed to significant risk during their product and supplier management process(es). Additionally, retailers often need to make rapid risk-based decisions on supplier and/or product remediation and substitution, and current approaches do not necessarily support new buying trends and order quantities. The retailers are also exposed to significant risks from gaps in their product and supplier management process(es). In particular, they need to identify suppliers responsible for poor quality and risky products.

Accordingly, there is an opportunity for more effective and efficient techniques for assessing risks and qualities associated with products and the suppliers of the products. Additionally, there is an opportunity to use machine learning techniques to leverage extracted product insights to inform changes to product development and supply chain quality processes to improve the safety and quality of products.

### SUMMARY

In an embodiment, a computer-implemented method of using machine learning to assess suppliers of products is provided. The method may include: training, by one or more computer processors, a plurality of intermediate machine learning models using a training dataset comprising: (i) a training set of testing, inspection, and/or certification (TIC) data associated with a test set of suppliers each being associated with a test set of products, (ii) a training set of transactional data associated with the test set of suppliers, and (iii) a training set of customer data associated with the test set of suppliers; training, by the one or more computer processors, an aggregate machine learning model based on a set of outputs from the plurality of intermediate machine learning models; storing the plurality of intermediate machine learning models and the aggregate machine learning model in a memory; accessing, by the one or more computer processors, information associated with a supplier, the information comprising (i) a set of TIC data associated with a set of products offered by the supplier, and (ii) a set of transactional data associated with the set of products; analyzing, by the one or more computer processors using the plurality of intermediate machine learning models, the information associated with the supplier, resulting in a plurality of intermediate outputs; and analyzing, by the one or more computer processors using the aggregate machine learning model, the plurality of intermediate outputs, to output a performance prediction for the supplier.

In another embodiment, a system for assessing suppliers of products is provided. The system may include: a memory storing a set of computer-readable instructions, a plurality of intermediate machine learning models, and an aggregate machine learning model; and at least one processor interfacing with the memory. The at least one processor may be configured to execute the set of computer-readable instructions to cause the at least one processor to: train the plurality of intermediate machine learning models using a training dataset comprising: (i) a training set of testing, inspection, and/or certification (TIC) data associated with a test set of suppliers each being associated with a test set of products, (ii) a training set of transactional data associated with the test set of suppliers, and (iii) a training set of customer data associated with the test set of suppliers, train the aggregate machine learning model based on a set of outputs from the plurality of intermediate machine learning models, access information associated with a supplier, the information comprising (i) a set of TIC data associated with a set of products offered by the supplier, and (ii) a set of transactional data associated with the set of products, analyze, using the plurality of intermediate machine learning models, the information associated with the supplier, resulting in a plurality of intermediate outputs, and analyze, using the aggregate machine learning model, the plurality of intermediate outputs, to output a performance prediction for the supplier.

In a further embodiment, a non-transitory computer-readable storage medium configured to store instructions executable by one or more processors may be provided. The instructions may include: instructions for training a plurality of intermediate machine learning models using a training dataset comprising: (i) a training set of testing, inspection, and/or certification (TIC) data associated with a test set of suppliers each being associated with a test set of products, (ii) a training set of transactional data associated with the test set of suppliers, and (iii) a training set of customer data associated with the test set of suppliers; instructions for training an aggregate machine learning model based on a set of outputs from the plurality of intermediate machine learning models; instructions for storing the plurality of intermediate machine learning models and the aggregate machine learning model in a memory; instructions for accessing information associated with a supplier, the information comprising (i) a set of TIC data associated with a set of products offered by the supplier, and (ii) a set of transactional data associated with the set of products; instructions for analyzing, using the plurality of intermediate machine learning models, the information associated with the supplier, resulting in a plurality of intermediate outputs; and instructions for analyzing, using the aggregate machine learning model, the plurality of intermediate outputs, to output a performance prediction for the supplier.

### BRIEF DESCRIPTION OF THE FIGURES

FIG. 1A depicts an overview of components and entities associated with the systems and methods, in accordance with some embodiments.

FIG. 1B depicts an overview of certain components configured to facilitate the systems and methods, in accordance with some embodiments.

FIG. 2 depicts a representation of various components associated with training various machine learning models, in accordance with some embodiments.

FIG. 3 depicts a representation of various components, modules, datasets, and data sources associated with the systems and methods, in accordance with some embodiments.

illustration of an example flow associated with certain machine learning functionalities, in accordance with some embodiments.

FIG. 3 depicts an example diagram including inputs and outputs associated with an example machine learning model, in accordance with some embodiments.

FIG. 4 is an example flow diagram associated with using machine learning to assess suppliers of products, in accordance with some embodiments.

FIG. 5 is an example hardware diagram of an electronic device and a server configured to perform various functionalities, in accordance with some embodiments.

### DETAILED DESCRIPTION

The present embodiments may relate to platforms and technologies for using machine learning to extract insights from performance data associated with in-market products, and leveraging these extracted insights to inform changes to product development and supply chain quality processes, and to improve the safety and quality of the products. According to aspects, various machine learning techniques may be used to train one or more machine learning models, and use the machine learning models to analyze data related to products and the lifecycles of the products, and output recommendations on how to mitigate risks and improve quality.

There are many aspects, challenges, and considerations associated with the lifecycle of products. Similarly, suppliers or other entities associated with the product lifecycle also face challenges and hurdles in planning and implementing product lifecycles. In particular, product suppliers must understand complex and fast-changing requirements, as well as proactively manage how changes in product design will impact regulatory compliance, which is usually done by connecting with expert systems and engineers.

Additionally, suppliers are consistently looking to enhance sourcing efficiency and minimize supply chain risks with real-time component analytics, improve operational efficiency with seamless compliance and certification lifecycle management, and improve regulatory compliance. Moreover, it is beneficial for suppliers to proactively identify product quality and safety risks, reduce the cost of managing complaints and returns, and improve the effectiveness of corrective and preventative actions (CAPA) management. The systems and methods as discussed herein enhance visibility into deeper layers of supply chain, streamline management through a risk-based scorecard, leverage digital and traditional tests, inspections, and certifications (TIC) services, manage growing product portfolios, and objectively rank products for improvement opportunities.

The systems and methods therefore offer many benefits. In particular, entities associated with the lifecycles of products may be afforded with relevant information on how to proactively address potential risks associated with products and suppliers, including those that may occur during the development, production, and post-production phases of a product's lifecycle. Additionally, the systems and methods may provide a higher degree of transparency and collaboration among various stakeholders, which can lead to improved product quality and safety. It should be appreciated that additional benefits are envisioned.

The systems and methods represent an improvement to an existing technology(ies), namely technologies for assessing supply chain conditions and implementing changes related thereto. Existing solutions are not able to effectively and efficiently analyze relevant data to ascertain risks presented by certain products and product suppliers. As a result, existing solutions do not allow for companies to effectively improve on aspects of the product lifecycle, which is costly for companies and other stakeholders, among other drawbacks.

The systems and methods improve on these existing technologies because the systems and methods incorporate multiple machine learning models that are trained using various data types reflective of performance of a set of products and suppliers in the marketplace. Each intermediate machine learning model assesses different aspects of the performance of products and/or product suppliers. The systems and methods also incorporate an aggregate machine learning model that assesses outputs of the intermediate machine learning models to determine or diagnose issues associated with the lifecycle or a particular product or with operations of a particular supplier, and/or to determine a recommendation associated with the design, testing, inspection, and/or distribution of a particular product.

Generally, the training data used to train the machine learning models encompasses large data sets related to the performance of products and suppliers within the marketplace. Further, the analysis of relevant input data using the hierarchical structure of the trained machine learning models represents an improvement on the discussed existing technologies because the machine learning models effectively and efficiently assess product and supplier performance, as well as effectively and efficiently determine recommendations for improving product and supplier performance in the marketplace. Additionally, the systems and methods update the machine learning model with data indicative of product supplier performance and recommendations, and/or other data, so that the machine learning model may be consistently up-to-date, leading to continued improvement in subsequent analyses by the machine learning model.

The training and use of the machine learning models enables the systems and methods to process large datasets that the existing systems are unable to analyze as a whole. This results in improved processing time by the systems and methods. Additionally, by virtue of employing the trained machine learning models in the analyses, the systems and methods reduce the overall amount of data retrieval and communication necessary for the analyses of marketplace data, reducing traffic bandwidth and resulting in cost savings.

The systems and methods discussed herein address a business challenge, namely a business challenge related to inefficiencies and challenges in assessing product and supplier performance. In conventional platforms, entities manually review various disparate data in an attempt to assess products and suppliers of products. In contrast, the systems and methods employ machine learning techniques to assess real-time product market performance data, thus enabling entities with access to useful information that may be used in structuring various aspects of the product supply chain.

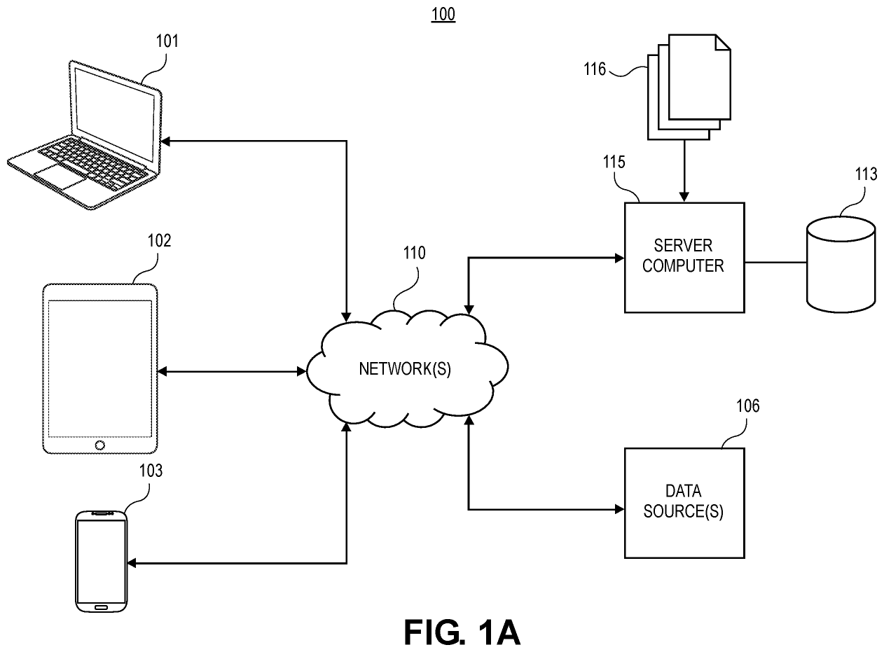

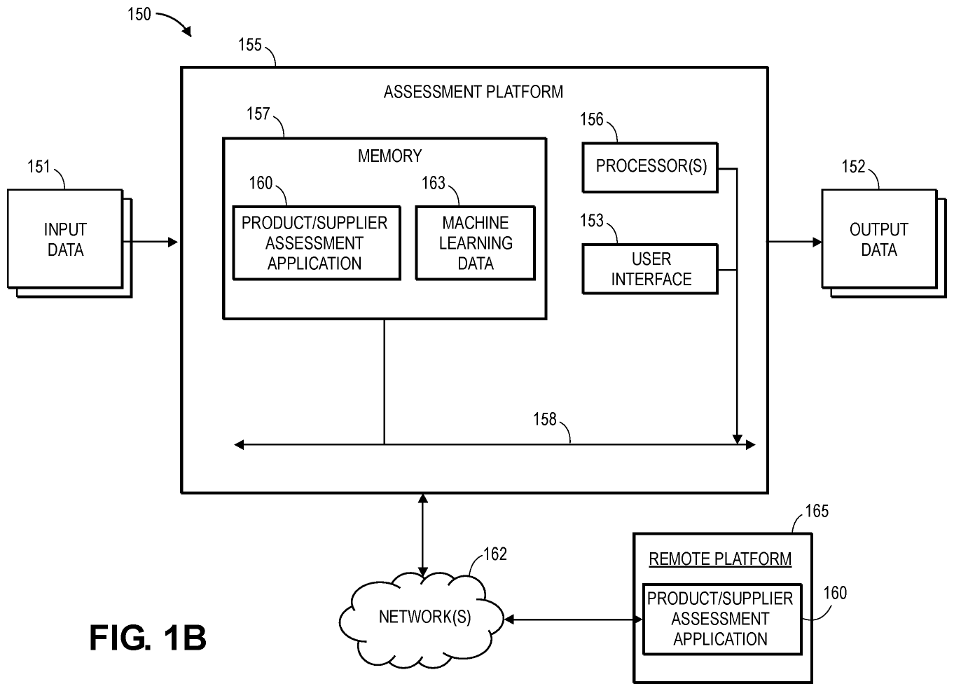

FIG. 1A illustrates an overview of a system 100 of components configured to facilitate the systems and methods. It should be appreciated that the system 100 is merely an example and that alternative or additional components are envisioned.

As illustrated in FIG. 1A, the system 100 may include a set of electronic devices 101, 102, 103. Each of the electronic devices 101, 102, 103 may be any type of electronic device such as a mobile device (e.g., a smartphone), desktop computer, notebook computer, tablet, phablet, GPS (Global Positioning System) or GPS-enabled device, smart watch, smart glasses, smart bracelet, wearable electronic, PDA (personal digital assistant), pager, computing device configured for wireless communication, and/or the like. In embodiments, any of the electronic devices 101, 102, 103 may be an electronic device associated with an entity such as a company, business, corporation, or the like (e.g., a server computer or machine).

The electronic devices 101, 102, 103 may communicate with a server computer 115 via one or more networks 110. In embodiments, the network(s) 110 may support any type of data communication via any standard or technology (e.g., GSM, CDMA, VoIP, TDMA, CDMA, LTE, EDGE, OFDM, GPRS, EV-DO, UWB, Internet, IEEE 802 including Ethernet, WiMAX, Wi-Fi, Bluetooth, and others). The server computer 115 may be associated with an entity such as a company, business, corporation, or the like, which designs, markets, manufactures, or sells products, or is otherwise involved in the supply chains of the products. The server computer 115 may include various components that support communication with the electronic devices 101, 102, 103.

The server computer 115 may communicate with one or more data sources 106 via the network(s) 110. In embodiments, the data source(s) 106 may compile, store, or otherwise access information associated with products, market information associated with products, suppliers of products, product sales and transaction data, test, inspection, and certification information, and/or other data or information. In particular, the data source(s) 106 may represent entities that compile these sets of data and provide these sets of data to the server computer 115. For example, one of the data source(s) 106 may be an aggregator of product transactional data.

According to embodiments, the server computer 115 may review or analyze data received from the data source(s) 106 to generally determine how products perform in the market as well as how suppliers of products perform in the market. In particular, the server computer 115 may analyze various data to determine a quantitative product score and/or a quantitative supplier score. Generally, a product, as described herein, may be any item or component that may be offered for sale and purchased by an end consumer, and is thus subject to various stages of the product supply chain including, for example, raw material supply, manufacture, distribution, retail, and/or other stages. Further, a supplier (or product supplier), as described herein, may be any entity (e.g., company) that is involved in or associated with any stage(s) of the product supply chain. For example; a product may be a television and a supplier of this product may be the manufacturer of the television.

Additionally, the server computer 116 may receive or access a training dataset 116 that includes various data and information associated with products and product suppliers including, for example, TIC data (e.g., “testing, inspection, and/or certification” data that may include testing reports, inspection reports, and/or certification reports), transactional data (e.g., product sales figures and volumes/quantities, product return data including figures and volumes/quantities, etc.), regulatory data (e.g., product safety recalls and/or similar information from external sources such as government websites, etc.), and customer data (e.g., reviews, complaints, ratings, etc.; which may be sometimes referred to as “voice of the customer” (VoC) data). It should be appreciated that the customer data may include reviews, complaints, and/or ratings for products that are sold and/or for the suppliers of the products. Further, it should be appreciated that the server computer 115 may receive the training dataset 116 from one of the data sources 106 or from another source.

According to embodiments, the server computer 115 may employ various machine learning techniques, calculations, algorithms, and the Ike to generate a set of intermediate machine learning models associated with respective portions of the training dataset 116. Further, the server computer 115 may train an aggregate machine learning model based on a set of outputs from the set of intermediate machine learning models.

According to embodiments, the server computer 115 may input a set of input data associated with a product and/or a supplier into the set of intermediate machine learning models, a result(s) of which may be input into the aggregate machine learning model, an output of which may represent a performance prediction for a given product or supplier.

The set of input data may originate from the electronic devices 101, 102, 103, or from another source (e.g., the data source 106). According to embodiments, a respective electronic device 101, 102, 103 may be operated by a user, and may generate or access a set of input data, associated with a product or supplier. The set of electronic devices 101, 102, 103 may transmit the set of input data to the server computer 115 via the network(s) 110.

The server computer 115 may be configured to interface with or support a memory or storage 113 capable of storing various data, such as in one or more databases or other forms of storage. According to embodiments, the storage 113 may store data or information associated with the machine learning models that are generated by the server computer 115. Additionally, the server computer 115 may access the data associated with the stored machine learning models to input a set of inputs into the machine learning models.

Although depicted as a single server computer 115 in FIG. 1A, it should be appreciated that the server computer 115 may be in the form of a distributed cluster of computers, servers, machines, or the like. In this implementation, the entity may utilize the distributed server computer(s) 115 as part of an on-demand cloud computing platform. Accordingly, when the electronic devices 101, 102, 103 interface with the server computer 115, the electronic devices 101, 102, 103 may actually interface with one or more of a number of distributed computers, servers, machines, or the like, to facilitate the described functionalities.

Although three (3) electronic devices 101, 102, 103, and one (1) server computer 115 are depicted in FIG. 1A, it should be appreciated that greater or fewer amounts are envisioned. For example, there may be multiple server computers, each one associated with a different entity.

FIG. 1B an example environment 150 in which a set of input data 151 is processed into output data 152 via an assessment platform 155, according to embodiments. In one implementation, the set of input data 151 may be a training dataset(s). The assessment platform 155 may be implemented on any computing device, including the server computer 115 (or in some implementations, one or more of the electronic devices 101, 102, 103) as discussed with respect to FIG. 1A. Components of the computing device may include, but are not limited to, a processing unit (e.g., processor(s) 156), a system memory (e.g., memory 157), and a system bus 158 that couples various system components including the memory 157 to the processor(s) 156. The computing device may further include various communication components (e.g., transceivers and ports) that may facilitate data communication with one or more additional computing devices.

In some embodiments, the processor(s) 156 may include one or more parallel processing units capable of processing data in parallel with one another. The system bus 158 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

The assessment platform 155 may further include a user interface 153 configured to present content (e.g., the content of the input data 151 and information associated therewith). Additionally, a user may make selections to the content via the user interface 153, such as to navigate through different information, review certain input data, and/or other actions. The user interface 153 may be embodied as part of a touchscreen configured to sense touch interactions and gestures by the user. Although not shown, other system components communicatively coupled to the system bus 158 may include input devices such as cursor control device (e.g., a mouse, trackball, touch pad, etc.) and keyboard (not shown). A monitor or other type of display device may also be connected to the system bus 158 via an interface, such as a video interface. In addition to the monitor, computers may also include other peripheral output devices such as a printer, which may be connected through an output peripheral interface (not shown).

The memory 157 may include a variety of computer-readable media. Computer-readable media may be any available media that can be accessed by the computing device and may include both volatile and nonvolatile media, and both removable and non-removable media. By way of non-limiting example, computer-readable media may comprise computer storage media, which may include volatile and nonvolatile, removable and non-removable media implemented in any method or technology for storage of information such as computer-readable instructions, routines, applications (e.g., a product/supplier assessment application 160), data structures, program modules or other data.

Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the processor 156 of the computing device.

The assessment platform 155 may operate in a networked environment and communicate with one or more remote platforms, such as a remote platform 165, via a network(s) 162, such as a local area network (LAN), a wide area network (WAN), telecommunications network, or other suitable network. The remote platform 165 may be implemented on any computing device, including one or more of the electronic devices 101, 102, 103, or the server computer 115 as discussed with respect to FIG. 1A, and may include many or all of the elements described above with respect to the platform 155. In some embodiments, as will be described herein, the product/supplier assessment application 160 as will be further described herein may be stored and executed by the remote platform 165 instead of by or in addition to the platform 155.

The product/supplier assessment application 160 may employ machine learning techniques such as, for example, a regression analysis (e.g., a logistic regression, linear regression, or polynomial regression), k-nearest neighbors, decisions trees, random forests, boosting, neural networks, support vector machines, deep learning, reinforcement learning, Bayesian networks, or the like. When the data 151 is a training dataset, the product/supplier assessment application 160 may analyze/process the data 151 to generate a set of machine learning models for storage as part of machine learning data 163 that may be stored in the memory 157.

When the data 151 comprises data associated with a product or supplier to be analyzed using the machine learning models, the product/supplier assessment application 160 may analyze or process the data 151 using the machine learning models to generate a set of output values (i.e., the output data 152) that may be indicative of a performance prediction in the market for a given product and/or supplier. Additionally, the product/supplier assessment application 160 may determine (i.e., as part of the output data 152) a set of recommendations for a given product or supplier, including recommendations related to design, testing, inspection, and distribution associated with the product lifecycle. In some situations, the product/supplier assessment application 160 may add, to the machine learning model(s), data resulting from its outputs and determinations so that the product/supplier assessment application 160 may use the updated machine learning model(s) in subsequent input data analysis. For example, the product/supplier assessment application 160 may determine that a determined recommendation was employed by a specific supplier, and the product/supplier assessment application 160 may update the machine learning model(s) to reflect that the determined recommendation was employed.

Generally, each of the data 151 and the data 152 may be embodied as any type of electronic document, file, template, etc., that may include various textual content, and may be stored in memory as program data in a hard disk drive, magnetic disk and/or optical disk drive in the assessment platform 155 and/or the remote platform 165.

The product/supplier assessment application 160 (or another component) may cause the output data 152 (and, in some cases, the training or input data 151) to be displayed on the user interface 153 for review by the user of the assessment platform 155. The user may select to review and/or modify the displayed data. For instance, the user may review the output data 152 to assess performance predictions and recommendations associated with products and suppliers.

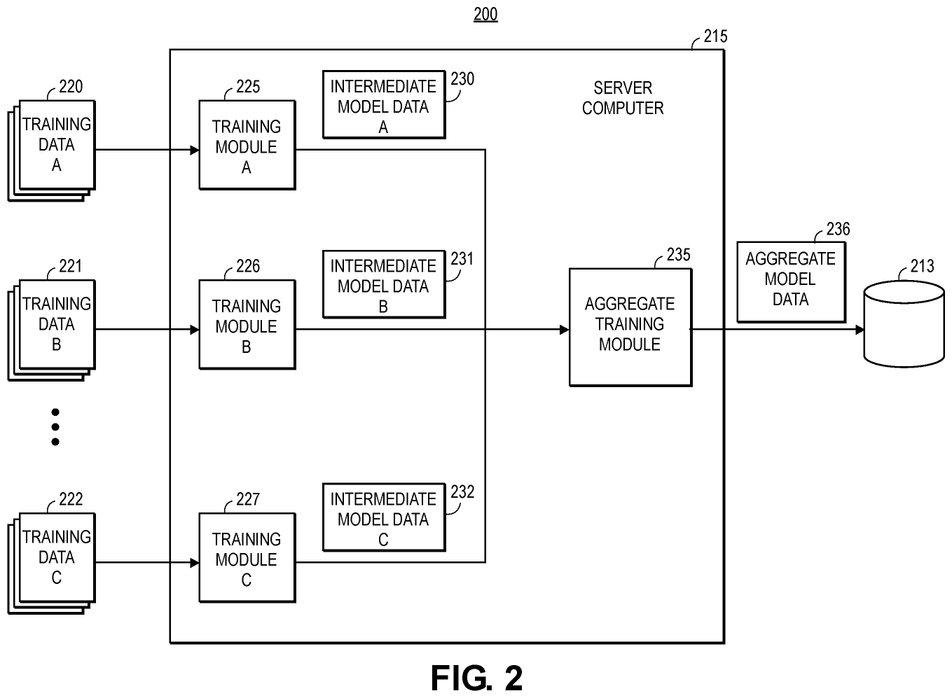

FIG. 2 depicts a representation 200 of components associated with training various machine learning models for use by the present embodiments. It should be appreciated that the datasets and associated components are merely exemplary, and that alternative or additional datasets and components are envisioned.

The representation 200 may include a server computer 215 (such as the server computer 115 as discussed with respect to FIG. 1A) and a memory or storage 213 (such as the memory or storage 113 as discussed with respect to FIG. 1A). Generally, the server computer 215 may support various machine learning techniques to train a set of machine learning models using a respective set of training data.

The representation 200 depicts training data A 220, training data B 221, and training data C 222. In an embodiment, training data A 220 may correspond to TIC data associated with a test set of products such as, for example, testing reports, inspection reports, certification reports, and/or the like; training data B 221 may correspond to transactional data associated with the test set of products such as, for example, sales figures and volumes/quantities, product return data including figures and volumes/quantities; and training data C 222 may correspond to customer data (i.e., VoC data) associated with the test set of products such as, for example, product reviews, product complaints, product ratings, and/or the like.

In another embodiment, training data A 220 may correspond to TIC data associated with a test set of suppliers each being associated with a test set of products such as, for example, testing reports, inspection reports, certification reports, and/or the like; training data B 221 may correspond to transactional data associated with the test set of suppliers such as, for example, sales figures and volumes/quantities, product return data including figures and volumes/quantities; and training data C 222 may correspond to customer data associated with the test set of suppliers such as, for example, product reviews, product complaints, product ratings, and/or the like.

That is, the training data A, B, C 220, 221, 222 may be product-specific or may be supplier-specific (where a given supplier may be a manufacturer, retailer, or other entity involved in the lifecycle of a given set of products). It should be appreciated that additional training data sets are envisioned such as, for example, regulatory data such as information indicating product recalls and/or similar information from external sources such as government websites, etc.

It should be appreciated that the training data A, B, C 220, 221, 222 may be labeled. For example, if a test product is a toothbrush, training data A 220 may include TIC reports for the toothbrush, training data B 221 may include data indicating sales and returns for the toothbrush, and training data C 222 may include reviews, complaints, and ratings for the toothbrush.

According to embodiments, the training data A, B, C 220, 221, 222 may be used to train respective machine learning models. In particular, a training module A 225 may use training data A 220 to train a machine learning model A that outputs intermediate model data A 230; a training module B 226 may use training data B 221 to train a machine learning model B that outputs intermediate model data B 231; and a training module C 227 may use training data C 222 to train a machine learning model C that outputs intermediate model data C 232.

According to embodiments, an aggregate training module 235 may train an aggregate machine learning model using intermediate model data A 230, intermediate model data B 231, and intermediate model data C 232, where the aggregate machine learning model may be embodied in aggregate model data 236. The memory or storage 213 may store the aggregate model data 236.

In embodiments, the aggregate model data 236 that embodies the aggregate machine learning model may reflect a trained machine learning model that may be used to perform various analyses that result in a variety of outputs. In particular, the aggregate machine learning model may be used to output a performance score for a particular product or for a particular supplier of a product(s). Additionally or alternatively, the aggregate machine learning model may be used to output a risk score for a particular product or for a particular supplier of a product(s), where the risk score may reflect a set of drawbacks or risks associated with the lifecycle of the particular product or the operations of the particular supplier. Additionally or alternatively, the aggregate machine learning model may be used to determine or diagnose issues associated with the lifecycle or a particular product or with operations of a particular supplier, and/or may be used to determine a recommendation associated with the design, testing, inspection, and/or distribution of a particular product.

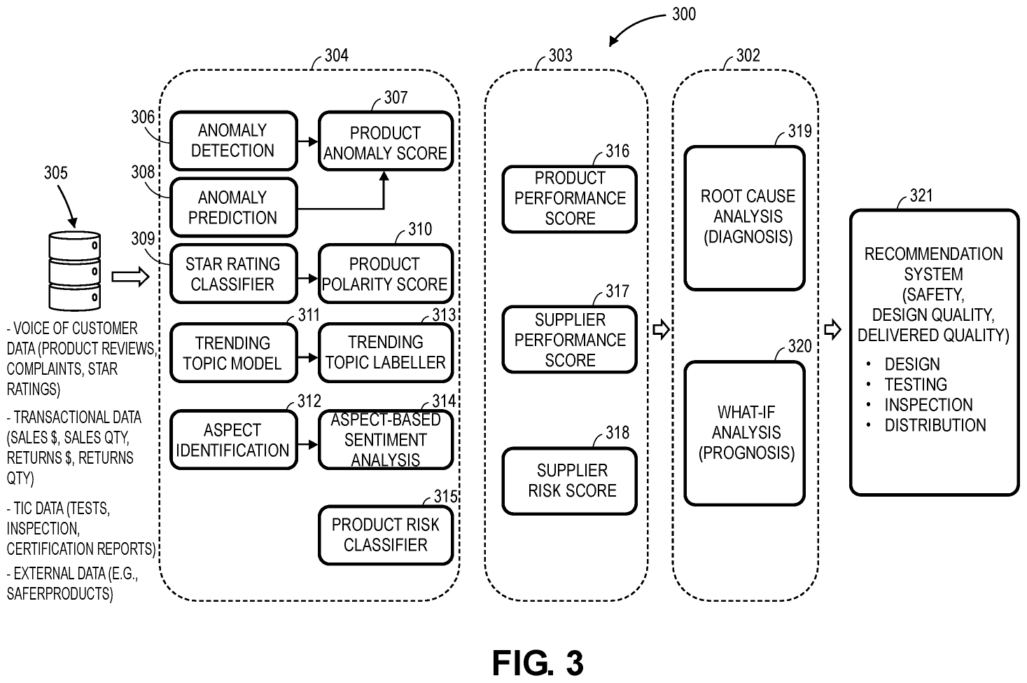

FIG. 3 depicts an overview 300 of various components, modules, datasets, data sources, and/or the like that may be involved in the present embodiments. It should be appreciated that the depicted elements are merely exemplary, and that alternative and additional elements are envisioned. Further, it should be appreciated that the components, modules, datasets, data sources, and/or the like as depicted in FIG. 3 may be incorporated into the machine learning analyses as discussed herein.

As illustrated in FIG. 3, various datasets 305 to be accessed, analyzed, or the like are envisioned. The datasets 305 may include a set of customer data (e.g., reviews and/or complaints associated with products, ratings for products, etc.); transactional data associated with products (e.g., sales amounts, sales quantities, returns amounts, returns quantities, etc.); data associated with tests, inspections, and certifications (TIC) of products, such as any TIC reports; and external data (e.g., safety data retrieved from government websites or other sources).

The overview 300 further includes, as indicated by reference 304, a set of components, modules, and/or the like that may be used to access and analyze the datasets 305. In particular, an anomaly detection component 306 may be configured to identify or determine, in the datasets 305, any unexpected items or events that may differ from the norm. Further, the anomaly detection component 306 may detect and/or predict any anomalous behavior related to any activity or entity, as well as provide any additional contextual information. For example, the anomaly detection component 306 may detect a high number of returns for a given product over a certain time period, or a sudden drop in sales of a given product, even though the given product has a high rating.

An anomaly prediction component 308 may be configured to determine or forecast anomalies from the datasets 305, such as to help retailers or other entities take various preventative actions. A product anomaly score component 307 may, based on outputs from the anomaly detection component 306 and the anomaly prediction component 308, calculate a score or metric indicative of detected anomalies on a product-by-product level. Generally, the score or metric may identify a product(s) that may need immediate attention due to unusual signals in the data.

A star rating classifier component 309 may be configured to assign, from reviews of products, ratings to the products (e.g., a star rating from one to five stars, where one star may signal negative reviews and five stars may signal positive reviews). A product polarity score component 310 may convert the ratings of products (e.g., the star ratings) to polarity scores (e.g., on a scale of 0-100, where 0 may signal negative feedback and 100 may signal positive feedback).

A trending topic model component 311 may determine or ascertain various themes or topics of interest to consumers. According to embodiments, the trending topic model component 311 may determine or ascertain emerging trends that may be significant or lead to an impact on a product or industry, as well as determine or lifeline or forecast the lifeline for a future impact. A trending topic labeler component 313 may label any topics as discovered by the trending topic model component 311, where a given label may be descriptive text for the topic, or some other description.

An aspect identification component 312 may identify or determine various aspects associated with products. An aspect-based sentiment analysis component 314 may be configured to predict a polarity (i.e., positive or negative) for a given product aspect, and in particular may identify different degrees of polarity towards a specific aspect associated with a given target. The aspect-based sentiment analysis component 314 may identify relevant information associated with a product, as contained in a review or a complaint for the product.

A product risk classifier component 315 may be configured to classify insights on reviews and complaints related to products, and categorizes reviews and components as certain categories. For example, if a given complaint for a TV contains the words “fire” and “smoke”, the product risk classifier component 315 may categorize the given complaint as a safety complaint.

The overview 300 further includes, as indicated by reference 303, a set of components, modules, and/or the like that may be used to calculate scores and metrics associated with products and suppliers of products.

In particular, a product performance score component 316 may determine a holistic measure of a performance (i.e., a score) of a given product over a given time period. According to embodiments, the product performance score component 316 may calculate the score based on various data included in the datasets 305 and/or on calculations by the components of 304. In particular, the product score may be calculated by combining sales data, returns data, product complaints, product reviews, risk profiles, anomalies, trending topics, and/or polarity scores/star ratings.

A supplier performance score component 317 may determine a holistic measure of a performance (i.e., a score) of a given supplier of a product. According to embodiments, the supplier performance score component 317 may calculate the score based on various data included in the datasets 305 and/or on calculations by the components of 304. In particular, the product score may be calculated by combining sales data, returns data, product complaints, product reviews, risk profiles, anomalies, trending topics, polarity scores/star ratings, testing, inspection, and certification data (e.g., product standards, variation notices, product construction features, etc.), and/or various external feedback (e.g., data from government websites, etc.).

The overview 300 further includes, as indicated by reference 302, a set of components, modules, and/or the like that may be used to diagnose and determine a prognosis for suppliers and products.

In particular, a root cause analysis component 319 may be configured to identify one or more causes of any identified problems, as well as a cause(s) of events detected or predicted through anomaly detection or reported in complaints and reviews, and determine an approach(es) for responding to the cause(s) or preventing the cause(s) from happening.

A what-if analysis component 320 may be configured to determine or simulate a potential effect(s) of any change(s) in the retail product life cycle on succeeding stages. For example, a change to an inspection defect library may impact customer satisfaction by being able to identify defective products earlier, which can be measured from reviews and complaints.

The overview 300 further includes a recommendation system 321 which may utilize any determination, output, or the like from the other components of the overview 300 to provide recommendations on changes to be made on various aspects of a product life cycle, including product design, testing, inspection, and distribution, such as to improve safety, design, quality, and delivered quality, among other improvements.

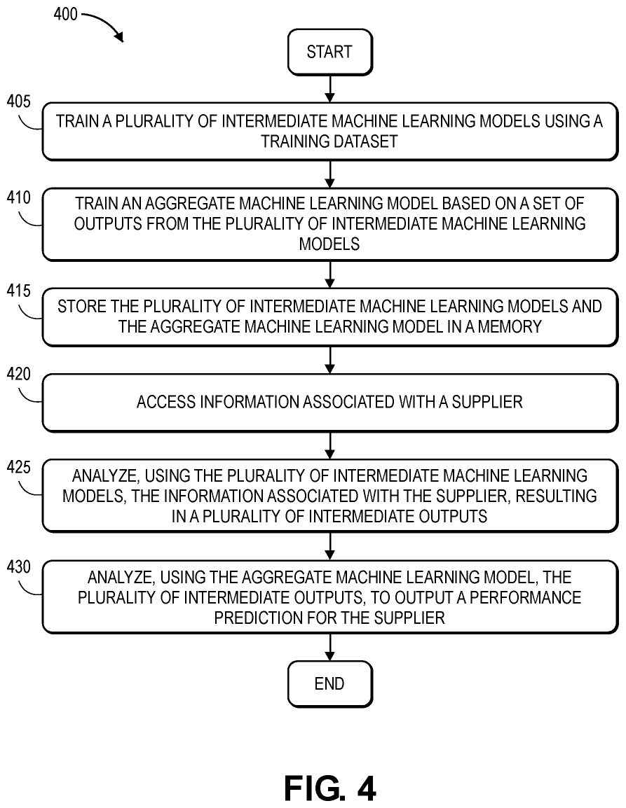

FIG. 4 depicts is a block diagram of an example method 400 of using machine learning to assess suppliers of products. The method 400 may be facilitated by a server (such as the server computer 115 as depicted in FIG. 1A). Although FIG. 4 describes assessing suppliers of products, it should be appreciated that the method 400 may be similarly used to assess products themselves.

The method 400 may begin at block 405 in which the server trains a plurality of intermediate machine learning models using a training dataset. According to embodiments, the training dataset may include (i) a training set of TIC data associated with a test set of suppliers each being associated with a test set of products, (ii) a training set of transactional data associated with the test set of suppliers, and (iii) a training set of customer data associated with the test set of suppliers. Further, in embodiments, the training set of TIC data associated with the test set of suppliers may include at least one of: a set of testing reports, a set of inspection reports, a set of certification reports, and/or the like; the training set of transactional data associated with the test set of suppliers may include at least one of: sales amounts, sales quantities, returns amounts, or returns quantities; and the training set of customer data associated with the test set of suppliers may include at least one of: reviews information, complaints information, or ratings information. It should be appreciated that additional training sets are envisioned, such as a training set of regulatory data that may include product safety recalls and/or similar information from external sources such as government websites and similar sources.

The server may train (block 410) an aggregate machine learning model based on a set of outputs from the plurality of intermediate machine learning models. According to embodiments, the set of outputs may include (i) a first output resulting from training a first intermediate machine learning model of the plurality of intermediate machine learning models, (ii) a second output resulting from training a second intermediate machine learning model of the plurality of intermediate machine learning models, and (iii) a third output resulting from training a third intermediate machine learning model of the plurality of intermediate machine learning models.

The server may store (block 415) the plurality of intermediate machine learning models and the aggregate machine learning model in a memory. Further, the server may access (block 420) information associated with a supplier. According to embodiments, the information may include (i) a set of TIC data associated with a set of products offered by the supplier, and (ii) a set of transactional data associated with the set of products.

The server may analyze (block 425), using the plurality of intermediate machine learning models, the information associated with the supplier, resulting in a plurality of intermediate outputs. Further, the server may analyze (block 430), using the aggregate machine learning model, the plurality of intermediate outputs, to output a performance prediction for the supplier. In embodiments, the server may additionally analyze, using the aggregate machine learning model, the plurality of intermediate outputs, to output a recommendation associated with the performance prediction. In embodiments, the server may access information associated with the supplier implementing or utilizing the recommendation. As a result, the server may update any of the intermediate machine learning models with the information, where the updated machine learning model(s) may be used in subsequent analyses.

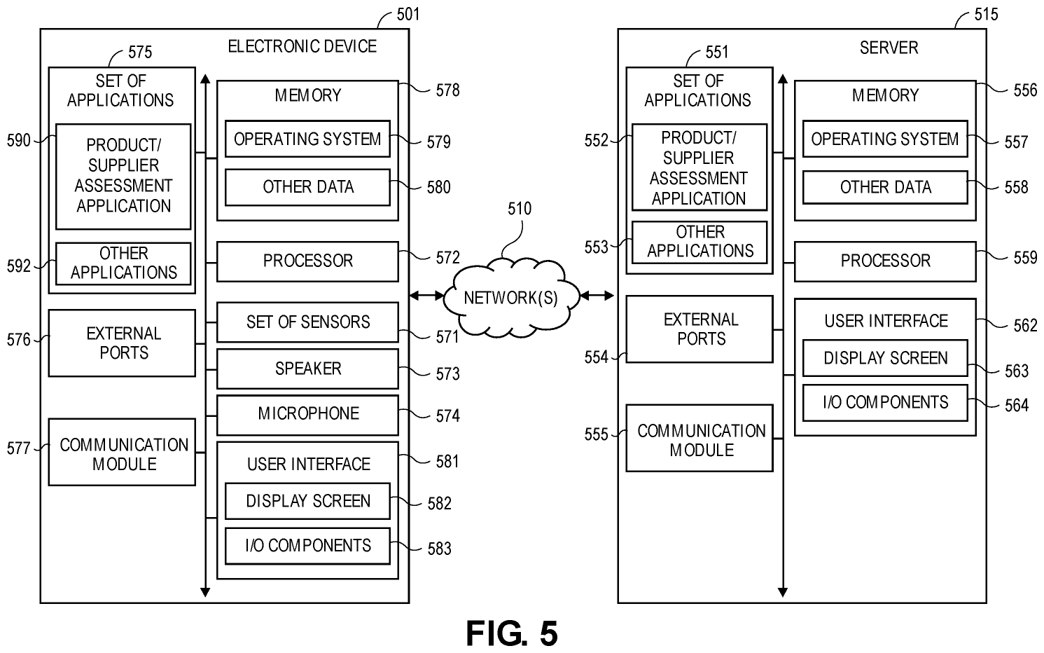

FIG. 5 illustrates a hardware diagram of an example electronic device 501 (e.g., one of the electronic devices 101, 102, 103 as described with respect to FIG. 1A) and an example server 515 (e.g., the server computer 115 as described with respect to FIG. 1A), in which the functionalities as discussed herein may be implemented. It should be appreciated that the components of the electronic device 501 and the server 515 are merely exemplary, and that additional or alternative components and arrangements thereof are envisioned.

The electronic device 501 may include a processor 572 as well as a memory 578. The memory 578 may store an operating system 579 capable of facilitating the functionalities as discussed herein as well as a set of applications 575 (i.e., machine readable instructions). For example, one of the set of applications 575 may be a product/suppler assessment application 590, such as to analyze relevant data and assess products and suppliers. It should be appreciated that one or more other applications 592 are envisioned.

The processor 572 may interface with the memory 578 to execute the operating system 579 and the set of applications 575. According to some embodiments, the memory 578 may also store other data 580 that may include TIC data, transactional data, customer data, and/or regulatory data associated with products and/or suppliers of products. The memory 578 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The electronic device 501 may further include a communication module 577 configured to communicate data via one or more networks 510. According to some embodiments, the communication module 577 may include one or more transceivers (e.g., WAN, WWAN, WLAN, and/or WPAN transceivers) functioning in accordance with IEEE standards, 3GPP standards, or other standards, and configured to receive and transmit data via one or more external ports 576.

The electronic device 501 may include a set of sensors 571 such as, for example, a location module (e.g., a GPS chip), an image sensor, an accelerometer, a clock, a gyroscope (i.e., an angular rate sensor), a compass, a yaw rate sensor, a tilt sensor, telematics sensors, and/or other sensors. The electronic device 501 may further include a user interface 581 configured to present information to a user and/or receive inputs from the user. As shown in FIG. 5, the user interface 581 may include a display screen 582 and I/O components 583 (e.g., ports, capacitive or resistive touch sensitive input panels, keys, buttons, lights, LEDs, and/or built in or external keyboard). Additionally, the electronic device 501 may include a speaker 573 configured to output audio data and a microphone 574 configured to detect audio.

In some embodiments, the electronic device 501 may perform the functionalities as discussed herein as part of a “cloud” network or may otherwise communicate with other hardware or software components within the cloud to send, retrieve, or otherwise analyze data.

As illustrated in FIG. 5, the electronic device 501 may communicate and interface with the server 515 via the network(s) 510. The server 515 may include a processor 559 as well as a memory 556. The memory 556 may store an operating system 557 capable of facilitating the functionalities as discussed herein as well as a set of applications 551 (i.e., machine readable instructions). For example, one of the set of applications 551 may be a product/suppler assessment application 552, such as to analyze relevant data and assess products and suppliers. It should be appreciated that one or more other applications 553 are envisioned.

The processor 559 may interface with the memory 556 to execute the operating system 557 and the set of applications 551. According to some embodiments, the memory 556 may also store other data 558 such as TIC data, transactional data, customer data, and/or regulatory data associated with products and/or suppliers of products. Further, the other data 558 may include various data associated with various machine learning models and the training thereof. The memory 556 may include one or more forms of volatile and/or nonvolatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 515 may further include a communication module 555 configured to communicate data via the one or more networks 510. According to some embodiments, the communication module 555 may include one or more transceivers (e.g., WAN, WWAN, WLAN, and/or WPAN transceivers) functioning in accordance with IEEE standards, 3GPP standards, or other standards, and configured to receive and transmit data via one or more external ports 554.

The server 515 may further include a user interface 562 configured to present information to a user and/or receive inputs from the user. As shown in FIG. 5, the user interface 562 may include a display screen 563 and I/O components 564 (e.g., ports, capacitive or resistive touch sensitive input panels, keys, buttons, lights, LEDs, external or built in keyboard). According to some embodiments, the user may access the server 515 via the user interface 562 to review information, make selections, and/or perform other functions.

In some embodiments, the server 515 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processors 572, 559 (e.g., working in connection with the respective operating systems 579, 557) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some embodiments, the computer program product may be part of a cloud network of resources.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

What is claimed is:

1. A computer-implemented method of using machine learning to assess suppliers of products, the method comprising:
training, by one or more computer processors, a plurality of intermediate machine learning models using a training dataset comprising: (i) a training set of testing, inspection, and/or certification (TIC) data associated with a test set of suppliers each being associated with a test set of products, (ii) a training set of transactional data associated with the test set of suppliers, and (iii) a training set of customer data associated with the test set of suppliers;
training, by the one or more computer processors, an aggregate machine learning model based on a set of outputs from the plurality of intermediate machine learning models;
storing the plurality of intermediate machine learning models and the aggregate machine learning model in a memory;
accessing, by the one or more computer processors, information associated with a supplier, the information comprising (i) a set of TIC data associated with a set of products offered by the supplier, and (ii) a set of transactional data associated with the set of products;
analyzing, by the one or more computer processors using the plurality of intermediate machine learning models, the information associated with the supplier, resulting in a plurality of intermediate outputs; and
analyzing, by the one or more computer processors using the aggregate machine learning model, the plurality of intermediate outputs, to output a performance prediction for the supplier.

2. The computer-implemented method of claim 1, wherein analyzing the plurality of intermediate outputs comprises:
analyzing, by the one or more computer processors using the aggregate machine learning model, the plurality of intermediate outputs, to output a recommendation associated with the performance prediction.

3. The computer-implemented method of claim 2, wherein analyzing the plurality of intermediate outputs to output the recommendation comprises:
outputting, by the aggregate machine learning model, information indicating a set of changes related to a development of the product or a supply chain associated with the supplier.

4. The computer-implemented method of claim 1, wherein the training set of TIC data associated with the test set of suppliers comprises at least one of: a set of testing reports, a set of inspection reports, or a set of certification reports, and wherein the training dataset further comprises a training set of regulatory data.

5. The computer-implemented method of claim 1, wherein the training set of transactional data associated with the test set of suppliers comprises at least one of: sales amounts, sales quantities, returns amounts, or returns quantities.

6. The computer-implemented method of claim 1, wherein the training set of customer data associated with the test set of suppliers comprises at least one of: reviews information, complaints information, or ratings information.

7. The computer-implemented method of claim 1, wherein the set of outputs comprises (i) a first output resulting from training a first intermediate machine learning model of the plurality of intermediate machine learning models, (ii) a second output resulting from training a second intermediate machine learning model of the plurality of intermediate machine learning models, and (iii) a third output resulting from training a third intermediate machine learning model of the plurality of intermediate machine learning models.

8. A system for assessing suppliers of products, comprising:
a memory storing a set of computer-readable instructions, a plurality of intermediate machine learning models, and an aggregate machine learning model; and
at least one processor interfacing with the memory, and configured to execute the set of computer-readable instructions to cause the at least one processor to:
train the plurality of intermediate machine learning models using a training dataset comprising: (i) a training set of testing, inspection, and/or certification (TIC) data associated with a test set of suppliers each being associated with a test set of products, (ii) a training set of transactional data associated with the test set of suppliers, and (iii) a training set of customer data associated with the test set of suppliers,
train the aggregate machine learning model based on a set of outputs from the plurality of intermediate machine learning models,
access information associated with a supplier, the information comprising (i) a set of TIC data associated with a set of products offered by the supplier, and (ii) a set of transactional data associated with the set of products,
analyze, using the plurality of intermediate machine learning models, the information associated with the supplier, resulting in a plurality of intermediate outputs, and
analyze, using the aggregate machine learning model, the plurality of intermediate outputs, to output a performance prediction for the supplier.

9. The system of claim 8, wherein to analyze the plurality of intermediate outputs, the at least one processor is configured to execute the set of computer-readable instructions to further cause the at least one processor to:
analyze, using the aggregate machine learning model, the plurality of intermediate outputs, to output a recommendation associated with the performance prediction.

10. The system of claim 9, wherein to analyze the plurality of intermediate outputs to output the recommendation, the at least one processor is configured to execute the set of computer-readable instructions to further cause the at least one processor to:
output, by the aggregate machine learning model, information indicating a set of changes related to a development of the product or a supply chain associated with the supplier.

11. The system of claim 8, wherein the training set of TIC data associated with the test set of suppliers comprises at least one of: a set of testing reports, a set of inspection reports, or a set of certification reports, and wherein the training dataset further comprises a training set of regulatory data.

12. The system of claim 8, wherein the training set of transactional data associated with the test set of suppliers comprises at least one of: sales amounts, sales quantities, returns amounts, or returns quantities.

13. The system of claim 8, wherein the training set of customer data associated with the test set of suppliers comprises at least one of: reviews information, complaints information, or ratings information.

14. The system of claim 8, wherein the set of outputs comprises (i) a first output resulting from training a first intermediate machine learning model of the plurality of intermediate machine learning models, (ii) a second output resulting from training a second intermediate machine learning model of the plurality of intermediate machine learning models, and (iii) a third output resulting from training a third intermediate machine learning model of the plurality of intermediate machine learning models.

15. A non-transitory computer-readable storage medium configured to store instructions executable by one or more processors, the instructions comprising:
instructions for training a plurality of intermediate machine learning models using a training dataset comprising: (i) a training set of testing, inspection, and/or certification (TIC) data associated with a test set of suppliers each being associated with a test set of products, (ii) a training set of transactional data associated with the test set of suppliers, and (iii) a training set of customer data associated with the test set of suppliers;
instructions for training an aggregate machine learning model based on a set of outputs from the plurality of intermediate machine learning models;
instructions for storing the plurality of intermediate machine learning models and the aggregate machine learning model in a memory;
instructions for accessing information associated with a supplier, the information comprising (i) a set of TIC data associated with a set of products offered by the supplier, and (ii) a set of transactional data associated with the set of products;
instructions for analyzing, using the plurality of intermediate machine learning models, the information associated with the supplier, resulting in a plurality of intermediate outputs; and
instructions for analyzing, using the aggregate machine learning model, the plurality of intermediate outputs, to output a performance prediction for the supplier.

16. The non-transitory computer-readable storage medium of claim 15, wherein the instructions for analyzing the plurality of intermediate outputs comprise:
instructions for analyzing, using the aggregate machine learning model, the plurality of intermediate outputs, to output a recommendation associated with the performance prediction.

17. The non-transitory computer-readable storage medium of claim 16, wherein the instructions for analyzing the plurality of intermediate outputs to output the recommendation comprise:
instructions for outputting, by the aggregate machine learning model, information indicating a set of changes related to a development of the product or a supply chain associated with the supplier.

18. The non-transitory computer-readable storage medium of claim 15, wherein the training set of TIC data associated with the test set of suppliers comprises at least one of: a set of testing reports, a set of inspection reports, or a set of certification reports, and wherein the training dataset further comprises a training set of regulatory data.

19. The non-transitory computer-readable storage medium of claim 15, wherein the training set of transactional data associated with the test set of suppliers comprises at least one of: sales amounts, sales quantities, returns amounts, or returns quantities.

20. The non-transitory computer-readable storage medium of claim 15, wherein the training set of customer data associated with the test set of suppliers comprises at least one of: reviews information, complaints information, or ratings information.
